(19) United States
(12) Patent Application Publication
(10) Pub. No.: US 2015/0283684 A1
(43) Pub. Date: Oct. 8, 2015

(54) Torque wrench

(71) Applicant: SANDVIK INTELLECTUAL PROPERTY AB, Sandviken (SE)

(72) Inventors: Claes PALSSON, Gavle (SE); Linus LARSSON, Goteborg (SE); Sebastian ROOS, Goteborg (SE); Caspar ANDREN, Goteborg (SE); Ove LARSSON, Vastra Frolunda (SE)

(21) Appl. No.: 14/679,115

(22) Filed: Apr. 6, 2015

(30) Foreign Application Priority Data
Apr. 7, 2014 (EP) 14163694.4

(51) Int. Cl. B25B 23/142; B25B 23/00

(52) U.S. Cl. CPC B25B 23/142; B25B 23/0007

(57) ABSTRACT

A torque wrench includes a rod, a wrench element attached to the rod, a gear disposed coaxially and non-rotatably on the rod, the gear having multiple teeth. The torque wrench further includes a housing including a cavity in which the rod and the gear are at least partially disposed, and a leaf spring arrangement in the cavity and including a spring fixed to the housing with a free edge of the spring engaging with the gear. The leaf spring arrangement prevents rotation of the gear and the rod relative to the housing when a torque below a first level is applied to the wrench element and permits rotation of the gear and the rod relative to the housing when a torque above the first level is applied to the wrench element.

### RELATED APPLICATION DATA

This application claims priority under 35 U.S.C. §119 to EP Patent Application No. 14163694.4, filed on Apr. 7, 2014, which the entirety thereof is incorporated herein by reference.

### TECHNICAL FIELD

The present disclosure relates to torque wrenches, and more particularly, to torque wrenches of a type in which torque is transmitted between a handle and a wrench element via a rod.

### BACKGROUND

It is often necessary or desirable to tighten fasteners with a specific amount of torque. For example, when fastening cutting inserts to tool holders with screws, if the insert is fastened with insufficient torque, it may loosen and fall off or break, or may move and damage a workpiece. If it is fastened too tightly, it may damage the insert or the fastener and may result in incorrect positioning of the insert relative to the tool holder.

For fastening of cutting inserts to tool holders, different tools and different cutting inserts often call for tightening to different amounts of torque. Providing different torque wrenches for each of these tools and inserts can be expensive. Moreover, many conventional torque wrenches are of inconvenient shapes and sizes for tightening of fasteners used on cutting tools. For example, the torque wrenches may be too large to be conveniently used in small spaces.

Prior art torque wrenches, such as that shown in EP 1 112 818 A1, tend to have unusual shapes that make them difficult to use in certain environment in which there is limited room to maneuver. The torque wrench of EP 1 112 818 A1, for example, has a large profile and an extended handle that makes it unsuitable for use in certain applications where space is minimal. In addition, wrenches such as that shown in EP 1 112 818 A1 includes multiple parts and can be difficult to manufacture. Even smaller wrenches, such as the wrench shown in DE 20 2013 102 682 U1, tend to include a substantial number of parts and can be difficult to manufacture.

It is therefore desirable to provide a torque wrench that can consistently apply torque to no higher than a desired level to a fastener. It is also desirable that the torque wrench be able to be constructed in a small shape that is convenient for torqueing fasteners on cutting tools. It is further desirable that the torque wrench be simple in construction so that it can be provided at a low cost.

### SUMMARY

In accordance with an aspect of the present disclosure, a torque wrench includes a rod, a wrench element attached to the rod, a gear disposed coaxially and non-rotatably on the rod, the gear having multiple teeth. The torque wrench has a housing including a cavity in which the rod and the gear are at least partially disposed. A leaf spring arrangement is in the cavity and includes a spring fixed to the housing with a free edge of the spring engaging with the gear, the leaf spring arrangement preventing rotation of the gear and the rod relative to the housing when a torque below a first level is applied to the wrench element and permitting rotation of the gear and the rod relative to the housing when a torque above the first level is applied to the wrench element.

The claimed structure has few components and is of minimal complexity, facilitating manufacture of the torque wrench at a low cost. In addition, the torque wrench can be manufactured in a shape that has a thin profile, permitting it to be used in a variety of different applications where space is minimal.

In accordance with another aspect of the present disclosure, the gear is attached to the rod. Such a structure facilitates easy manufacture of the wrench.

In accordance with another aspect of the present disclosure, the wrench element comprises a male key. Such a structure is particularly useful in tightening of screws for fastening cutting inserts on tool holders.

In accordance with another aspect of the present disclosure, the teeth of the gear are asymmetrical. Such a structure facilitates providing a torque wrench that tightens only when turned in one direction.

In accordance with another aspect of the present disclosure, the teeth of the gear have a clockwise side and a counterclockwise side, the counterclockwise side having a steeper slope than the clockwise side. Such a structure facilitates providing a torque wrench that tightens to a predetermined torque when turned in a clockwise direction, and further permits a higher torque to be applied when untightening i.e. when turned in a counterclockwise direction.

In accordance with another aspect of the disclosure, one side of the teeth of the gear apply a force to the spring that is substantially perpendicular to the spring when the wrench is turned in a first direction and another side of the teeth of the gear apply a force to the spring that is substantially parallel to a length of the spring when the wrench is turned in a second direction opposite the first direction. Such a structure facilitates providing a torque wrench having 10-40 times greater release torque than tightening torque.

In accordance with another aspect of the present disclosure, the spring includes a plate having a fixed edge and the free edge. Such a structure facilitates manufacture of the torque wrench with simple components and at low cost.

In accordance with another aspect of the present disclosure, the spring is a flat plate. Such a structure facilitates manufacture of the torque wrench with simple components and at low cost.

In accordance with another aspect of the present disclosure, a plane of a surface of the spring, when the spring is in a relaxed state, is offset from a center axis of the rod. Such a structure facilitates adjustment of the amount of torque that can be applied by the torque wrench in a simple manner by altering the amount of offset.

In accordance with another aspect of the present disclosure, the leaf spring arrangement includes the spring and top and bottom spring holders, the top and bottom spring holders being immovably disposed in the cavity, the free edge of the spring of the leaf spring arrangement being disposed between top and bottom edges of the spring, the spring having top and bottom ears extending from the top and bottom edges, respectively, and the top and bottom ears being immovably disposed in openings in the top and bottom spring holders, respectively. Such a structure facilitates adjustment of the amount of torque that can be applied by the torque wrench in a simple manner by altering the location of the openings in the top and bottom spring holders so that the spring is positioned differently relative to the gear on the rod.

In accordance with another aspect of the present disclosure, an interior shape of the cavity matches shapes of perimeters of the spring holders so that the spring holders are immovably disposed in the cavity. Such a structure facilitates providing different torque wrenches capable of providing torques of different levels by simply using different spring holders in housings having the same cavity shape.

In accordance with another aspect of the present disclosure, the gear is axially immovable relative to the rod and extends between the top and bottom spring holders so that the rod is axially immovable relative to the housing. Such a structure provides for a convenient way of fixing the multiple components of the torque wrench relative to each other in a simple, easy to manufacture manner.

In accordance with another aspect of the present disclosure, the leaf spring arrangement has two springs disposed between the top and bottom spring holders and on opposite sides of the gear. Such a structure facilitates designing the torque wrench so that a larger amount of torque can be applied through the torque wrench than if a single spring were used.

In accordance with another aspect of the present disclosure, the two springs are rotationally symmetric. Such a structure facilitates design of the torque wrench as each spring can require the same amount of force to be deflected.

In accordance with another aspect of the present disclosure, the housing includes a top cover defining the cavity and a bottom cover attachable to the top cover to retain the leaf spring arrangement in the cavity. Such a structure provides for a convenient way of fixing the multiple components of the torque wrench relative to each other in a simple, easy to manufacture manner.

### BRIEF DESCRIPTION OF THE DRAWINGS

The features and advantages of the present disclosure are well understood by reading the following detailed description in conjunction with the drawings in which like numerals indicate similar elements and in which:

FIG. 1 is a perspective view of a torque wrench according to an embodiment of the present disclosure.

FIG. 2A is a front view of the torque wrench of FIG. 1.

FIG. 2B is a side view of the torque wrench of FIG. 1.

FIG. 2C is a top view of the torque wrench of FIG. 1.

FIG. 2D is a cross-sectional view taken at section I-I of FIG. 2B.

FIG. 2E is a cross-sectional view taken at section II-II of FIG. 2A.

FIG. 2F shows the view of FIG. 2E with springs deflected.

FIG. 2G is a cross-sectional view taken at section III-III of FIG. 2A.

FIG. 2H is an enlarged view of a portion of FIG. 2E.

FIG. 3 is an exploded view of a torque wrench according to an embodiment of the present disclosure.

FIGS. 4A-4B are cross-sectional views showing how a wrench according to an embodiment of the present disclosure tightens to a torque limit.

FIGS. 4C-4D are cross-sectional views showing how the wrench of FIGS. 4A-4B loosens an article that has been torqued.

FIG. 5 is a perspective view of a torque wrench according to another embodiment of the present disclosure.

FIG. 6A is a front view of the torque wrench of FIG. 5.

FIG. 6B is a side view of the torque wrench of FIG. 5.

FIG. 6C is a cross-sectional view taken at section IV-IV of FIG. 6A.

FIG. 7A is top view of a torque wrench according to another embodiment of the present disclosure.

FIG. 7B is a cross-sectional view taken at section V-V of FIG. 7A.

FIG. 8A is top view of a torque wrench according to another embodiment of the present disclosure.

FIG. 8B is a cross-sectional view taken at section VI-VI of FIG. 8A.

### DETAILED DESCRIPTION

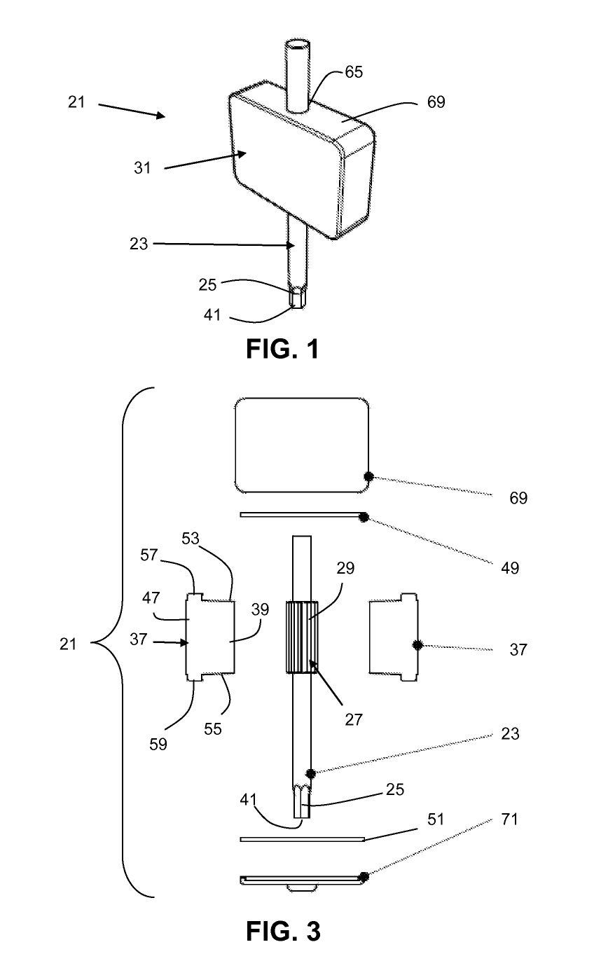

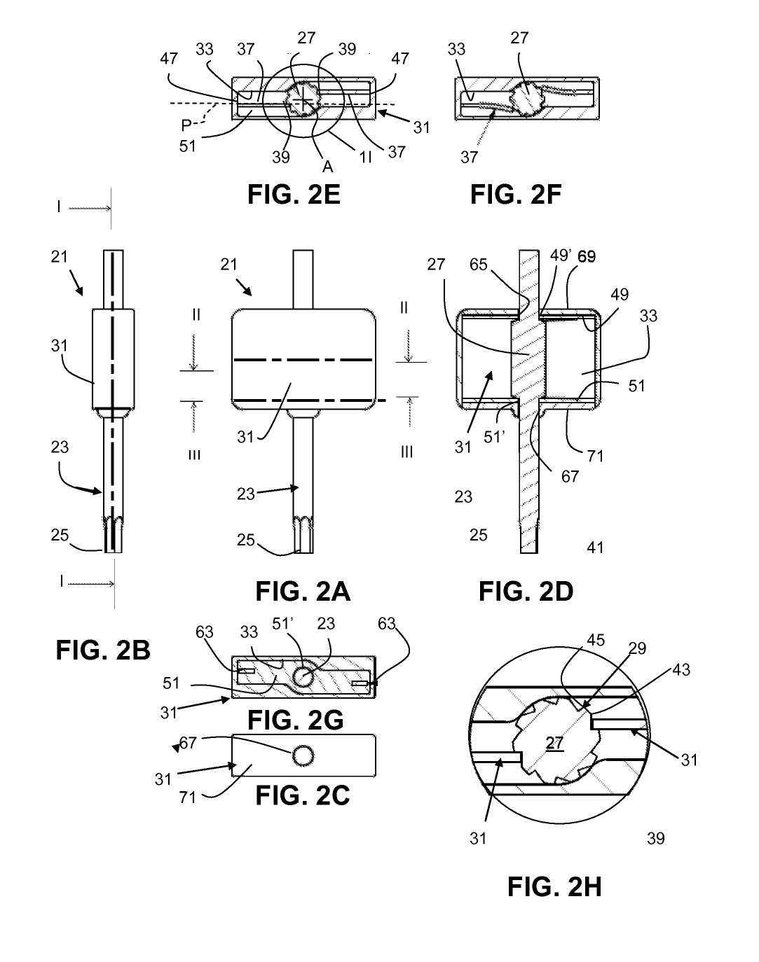

A torque wrench 21 according to an aspect of the present disclosure is illustrated in FIGS. 1-2H and includes a rod 23, a wrench element 25 attached to the rod, and a gear 27 (FIGS. 2D-2F, 2H, and 3) disposed coaxially and non-rotatably on the rod, the gear having multiple teeth 29 (FIGS. 2E-2F, 2H, and 3). The torque wrench 21 further includes a housing 31 having a cavity 33 (FIGS. 2D-2G) in which the rod 23 and the gear 27 are at least partially disposed.

A leaf spring arrangement is disposed in the cavity 33 and includes a spring 37 (FIGS. 2E, 2F, 2H, and 3) fixed to the housing 31 with a free edge 39 (e.g., FIGS. 2E and 3) of the spring engaging with the gear 27. The leaf spring arrangement prevents rotation of the gear 27 and the rod 23 relative to the housing 31 when a torque below a first level is applied to the wrench element 25 and permits rotation of the gear and the rod relative to the housing when a torque above the first level is applied to the wrench element. This is achieved, as seen in FIGS. 2E and 2F, by applying a torque to the wrench element that is transmitted through the rod 23 to the gear 27, so that the teeth 29 of the gear are urged against the free edge 39 of the spring 37. Until the torque applied to the wrench element is sufficient to deform the spring 37, as shown in FIG. 2F, the torque applied to the wrench element will be transmitted to the housing 31. The housing 31 can function as a handle of the torque wrench 21, so that when a user applies a torque to the housing, it is transmitted through the spring 37 to the gear 27 and rod 23 to the wrench element 25 and thus, to a fastener or other object being tightened or loosened.

The gear 27 can be attached to the rod 23, such as by being integrally formed with the rod or by being fixed to a rod passing through a central opening of the gear by any suitable means such as a set screw, adhesive, welding, brazing, or the like. The illustrated wrench element 25 is shown as a male key, however, other types of wrench elements can be provided, such as sockets or open ended wrenches. The wrench element 25 can be formed at an end 41 of the rod 23 and may be integral with the rod, or may be attached to the end of the rod by any suitable means.

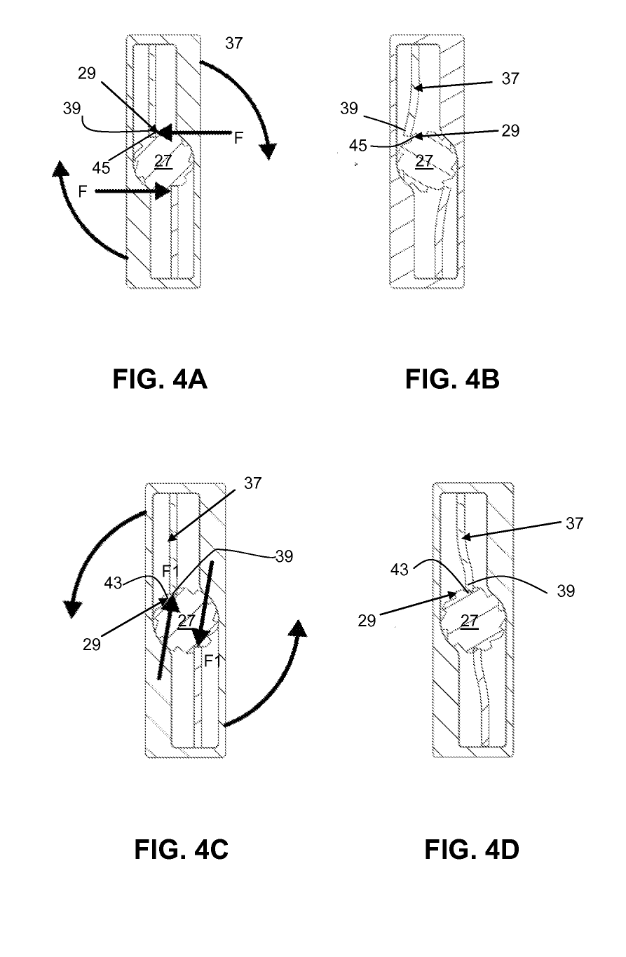

The teeth 29 of the gear 27 can be symmetrical, however, as seen in, e.g., FIG. 2H, they will ordinarily be asymmetrical to facilitate tightening when the wrench is turned in a clockwise direction. When the teeth 29 are asymmetrical, as illustrated in FIGS. 2E, 2F, and 2H, the teeth of the gear can have a clockwise side 43 and a counterclockwise side 45 (FIG. 2H), and the counterclockwise side has a steeper slope than the clockwise side. The manner in which the springs 37 and gear 27 function to provide for torquing when the wrench is turned in a clockwise direction and loosening when the wrench is turned in a counterclockwise direction is discussed in connection with FIGS. 4A-4D.

The spring 37 of the leaf spring arrangement can have a plate having a fixed edge 47 and the free edge 39. The material from which the spring 37 is formed will ordinarily be metal, however, different materials may be desired to alter the level of torque that can be transmitted by the wrench. Ordinarily, the spring 37 will be in the form of a flat plate, however, the spring can have a variety of alternative shapes as desired or necessary. A curved shape may, for example, be desirable to alter the level of torque that can be transmitted by the wrench 21.

As seen in FIG. 2E, when the spring 37 is flat, a plane P of a surface of the spring, when the spring is in a relaxed state, can be offset from a center axis A of the rod 23. Increasing or decreasing the amount of offset of the plane P of the surface of the spring 37 from the center axis A of the rod 23 can alter the amount of torque necessary to be applied to the wrench 21 in order to deflect the spring 37, so that no more torque can be transmitted. Decreasing the offset will ordinarily tend to increase the amount of torque that can be transmitted. When increasing or decreasing the amount of offset, also the dimension of the gear 27 must be adjusted to keep the functionality. Another function of the offset is to facilitate loosening a fastener by ensuring that the spring 37 does not tend to deflect when the wrench is turned in a loosening direction. This is discussed in more detail in connection with FIGS. 4A-4D below.

As seen in FIGS. 2D, 2G, and 3, the leaf spring arrangement can include the spring 37 and top and bottom spring holders 49 and 51. The top and bottom spring holders 49 and 51 are immovably disposed in the cavity 33, such as by the spring holders having perimeter shapes that match an interior shape of the cavity, or that can be retained by portions of the surface of the cavity. The top and bottom spring holders 49 and 51 can be identical. The free edge 39 of the spring 37 of the leaf spring arrangement is disposed between top and bottom edges 53 and 55 (FIG. 3) of the spring, and the spring can have top and bottom ears 57 and 59 (FIG. 3) extending from the top and bottom edges, respectively, and extending to the fixed edge 47 of the spring. The top and bottom ears 57 and 59 can be immovably disposed in openings 63 in the top and bottom spring holders 49 and 51 (FIG. 2G showing opening in bottom spring holder 51, which can be identical to top spring holder), respectively, thus fixing the fixed edge 47 of the spring 37 relative to the housing 31. Different spring holders 49 and 51 having openings 63 in different locations can be used in different wrenches to provide for a different amount of offset of the plane P of the surface of the spring 37 from the axis A of the rod 23. In this way, the same housing 31, rod 23, gear 27, and springs 37 can be used with different spring holders 49 and 51 to provide torque wrenches that permit torqueing to different levels. The spring holders 49 and 51 have been found to facilitate providing a highly secure mounting of the springs 37 relative to the housing 31. The more secure the mounting, the more that torqueing is due solely to deflection of the spring, which can facilitate providing torqueing to accurate levels and which can facilitate keeping the size of the wrench to a minimum. By providing the spring holders 49 and 51 with an S-shape as illustrated, the amount of material used to make the spring holders can be kept to a minimum while still providing a solid feel to the wrench.

The gear 27 can be axially immovable relative to the rod 23 and can extend an entire distance between the top and bottom spring holders 49 and 51 so that the rod is axially immovable relative to the housing 31. The rod 23 can extend through holes 49′ and 51′ (FIG. 2D) in the top and bottom spring holders 49 and 51 and through holes 65 and 67 (FIG. 2D) in a top cover 69 and a bottom cover 71 (FIGS. 2D and 3) that define the cavity 33 of the housing 31 so that the rod and gear 27 are rotatable relative to the housing. The top cover 69 and bottom cover 71 retain the leaf spring arrangement in the cavity. By providing different leaf spring arrangements, the same housing can be used to provide torque wrenches that permit torqueing to different levels.

In the embodiments shown in FIGS. 1-3, the leaf spring arrangement has two springs 37 disposed between the top and bottom spring holders 49 and 51 and on opposite sides of the gear 29. The two springs 37 can be rotationally symmetric. As seen, however, in FIGS. 4A-4D, the wrench 21′ may have a single spring 37′ (FIG. 2C). Providing two springs can facilitate providing a torque wrench that limits torque at higher levels than a wrench with a single spring (assuming the springs are of the same type). In either case, the manner of positioning the springs 37 or 37′ relative to the gear 29 facilitates providing a torque wrench having a thin profile so that the torque wrench is well-adapted for use in tight spaces. Wrenches with more than two springs can also be provided, such as by providing wider or differently shaped housing, such as a circular housing, so that additional springs can be provided.

FIGS. 4A-4B show how, when a wrench is turned in a clockwise direction, it can perform a tightening operation until it reaches a torque transmission limit when the springs 37 deflect to a position as shown in FIG. 4B. FIGS. 4C-4D show how, when the wrench is turned in a counterclockwise direction, it can perform a loosening operation. In FIG. 4A, when the housing 31 is turned in a clockwise direction as shown to torque an item such as a fastener, a force F is applied via the ends 39 of the springs 37 to the counterclockwise side 45 of the teeth 29 of the gear 27. The force F is substantially perpendicular to the spring 37. When the force F exceeds the ability of the springs 37 to resist deflection beyond a point at which the teeth 29 of the gear 27 can turn relative to the housing, then the torque limit of the wrench is reached. The torque limit of the wrench can be set by calculating the amount of torque necessary to deflect the springs 37 based on ordinary beam theory.

To loosen an item, such as a fastener that has been torqued, the wrench is turned in a counterclockwise direction as shown in FIGS. 4C-4D. In this case, the clockwise face 43 of a tooth 29 of the gear is turned toward the end 39 of the spring 37 and the force F1 attacks the spring from a different direction than during tightening, that direction being largely in a direction of a length of the spring as seen in FIG. 4C. In other words the force F1 is substantially parallel to a length of the spring 37. Typically an angle (not shown) formed between the force F1 and a direction of length of the spring should be smaller or equal to 5 degrees, and more preferably smaller or equal to 2.5 degrees. The application of the force F1 will tend to cause buckling of the springs 37 as shown in FIG. 4D. Thus, contrary to the force F, the force F1 will not cause any deflection of the spring 37. Thereby a much higher force can be applied when loosening a screw. Buckling will in practice not occur during normal use of the wrench, it is merely shown in FIG. 4D to illustrate the effect of the force F1.

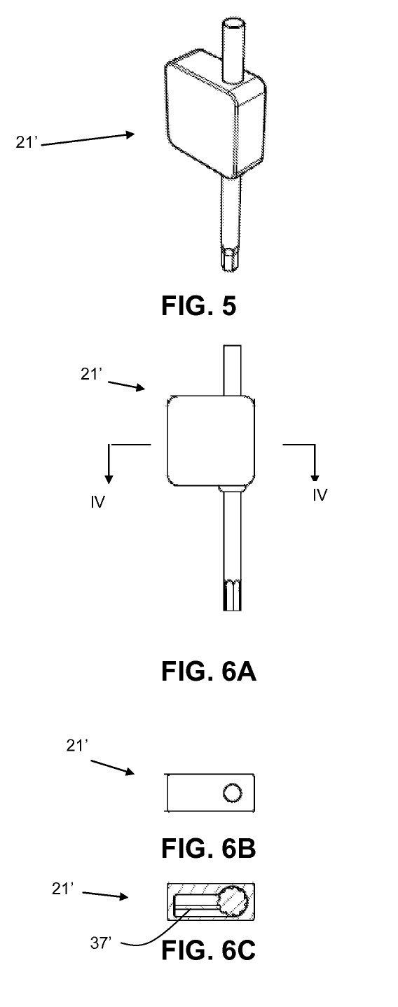

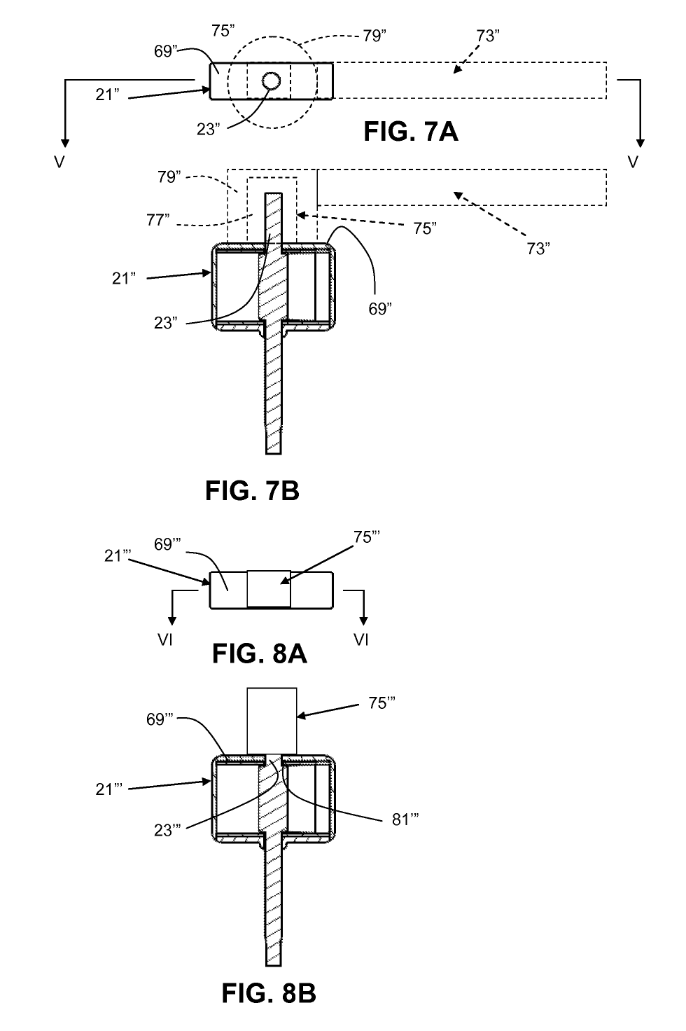

FIGS. 5-7B show two embodiments that can be used in connection with a handle or, preferably, a conventional ratcheting handle 73″ as shown in phantom in FIGS. 5-6A. FIGS. 7A-7B show a wrench 21″ that is substantially the same as the wrench 21 shown in FIGS. 1-2H, except that a male drive connection 75″ is provided on the top cover 69″ of the wrench. The rod 23″ can extend into a cavity 77″ (FIG. 7B) inside the male drive connection 75″. The male drive connection 75″ mates with a female drive connection 79″ on the ratcheting handle.

FIGS. 8A-8B show another embodiment of a wrench 21′ useful with a handle or ratcheting handle (not shown in FIGS. 8A-8B), however, in this embodiment, the top end of the rod 23′ is received in a recess 81′ (FIG. 8B) in the top cover 69′, and the male drive connection 75′″ is solid. The embodiments shown in FIGS. 7A-8B may be particularly useful when it is necessary to provide torqueing forces in excess of what can conveniently be provided by using the housing 31 alone to provide leverage.

In some cases, it may be useful to provide a number of springs in excess of or larger than the two illustrated in FIGS. 1-2H, and it may be useful to provide housings that are less rectangular and more round, possibly completely circular. The housing 31 in FIGS. 1-2H is illustrated as being rectangular in shape, however, it will be appreciated that it can be any desired shape.

In the present application, the use of terms such as “including” is open-ended and is intended to have the same meaning as terms such as “comprising” and not preclude the presence of other structure, material, or acts. Similarly, though the use of terms such as “can” or “may” is intended to be open-ended and to reflect that structure, material, or acts are not necessary, the failure to use such terms is not intended to reflect that structure, material, or acts are essential. To the extent that structure, material, or acts are presently considered to be essential, they are identified as such.

While this disclosure has been illustrated and described in accordance with a preferred embodiment, it is recognized that variations and changes may be made therein without departing from the disclosure as set forth in the claims.

1. A torque wrench, comprising:
a rod;
a wrench element attached to the rod;
a gear disposed coaxially and non-rotatably on the rod, the gear having multiple teeth;
a housing including a cavity in which the rod and the gear are at least partially disposed; and
a leaf spring arrangement disposed in the cavity, the leaf spring arrangement including a spring fixed to the housing with a free edge of the spring engaging with the gear, the leaf spring arrangement preventing rotation of the gear and the rod relative to the housing when a torque below a first level is applied to the wrench element and permitting rotation of the gear and the rod relative to the housing when a torque above the first level is applied to the wrench element.

2. The torque wrench as set forth in claim 1, wherein the gear is attached to the rod.

3. The torque wrench as set forth in claim 1, wherein the wrench element comprises a male key.

4. The torque wrench as set forth in claim 3, wherein the male key is formed at an end of the rod.

5. The torque wrench as set forth in claim 1, wherein the teeth of the gear are asymmetrical.

6. The torque wrench as set forth in claim 1, wherein the teeth of the gear have a clockwise side and a counterclockwise side, the counterclockwise side having a steeper slope than the clockwise side.

7. The torque wrench as set forth in claim 1, wherein one side of the teeth of the gear apply a force to the spring that is substantially perpendicular to the spring when the wrench is turned in a first direction and another side of the teeth of the gear apply a force to the spring that is substantially parallel to a length of the spring when the wrench is turned in a second direction opposite the first direction.

8. The torque wrench as set forth in claim 1, wherein the spring includes a plate having a fixed edge and the free edge.

9. The torque wrench as set forth in claim 1, wherein the spring is a flat plate.

10. The torque wrench as set forth in claim 9, wherein a plane of a surface of the spring, when the spring is in a relaxed state, is offset from a center axis of the rod.

11. The torque as set forth in claim 1, wherein the leaf spring arrangement includes the spring and top and bottom spring holders, the top and bottom spring holders being immovably disposed in the cavity, the free edge of the spring of the leaf spring arrangement being disposed between top and bottom edges of the spring, the spring having top and bottom ears extending from the top and bottom edges, respectively, the top and bottom ears being immovably disposed in openings in the top and bottom spring holders, respectively.

12. The torque wrench as set forth in claim 11, wherein the gear is axially immovable relative to the rod and extends between the top and bottom spring holders so that the rod is axially immovable relative to the housing.

13. The torque wrench as set forth in claim 11, wherein the leaf spring arrangement a plurality of springs disposed between the top and bottom spring holders and on opposite sides of the gear.

14. The torque wrench as set forth in claim 13, wherein the plurality of springs are rotationally symmetric.

15. The torque wrench as set forth in claim 1, wherein the housing includes a top cover defining the cavity and a bottom cover attachable to the top cover to retain the leaf spring arrangement in the cavity.
